(19) United States
(12) Patent Application Publication
(10) Pub. No.: US 2020/0246846 A1
(43) Pub. Date: Aug. 6, 2020

(54) Cleaning Device

(71) Applicant: Scot Young Research Limited, Stourbridge (GB)

(72) Inventors: Lee Staves, Stourbridge (GB); Dominic Keeley, Stourbridge (GB)

(21) Appl. No.: 16/727,097

(22) Filed: Dec. 26, 2019

(30) Foreign Application Priority Data
Feb. 1, 2019 (GB) 1901438.0

(51) Int. Cl. B08B 9/087; A47J 39/02

(52) U.S. Cl. CPC B08B 9/087; B08B 2209/08; A47J 39/02

(57) ABSTRACT

A cleaning device for cleaning a warming drawer is described, the cleaning device comprising a body portion and at least one cleaning member peripherally mounted on the body portion. The body portion further comprises an aperture; or a recess in a side of the body portion; wherein the aperture or the recess extends through the thickness of the body portion. In this way, an improved device for cleaning a warming drawer is provided. A method of cleaning a warming drawer and a kit of parts is also described.

### CROSS-REFERENCE TO RELATED APPLICATIONS

This application claims priority under the Paris Convention to United Kingdom Patent Application No. 1901438.0, filed Feb. 1, 2019, the entire content of which is herein incorporated.

### STATEMENT REGARDING FEDERALLY SPONSORED RESEARCH OR DEVELOPMENT

Not Applicable

### BACKGROUND OF THE INVENTION

### 1. Field of Invention

The present invention relates to a cleaning device, and more particularly to a cleaning device for cleaning a warming drawer.

### 2. Description of the Related Art

Warming drawers including a movable drawer within a housing are commonplace in commercial and private kitchens. Typically, warming drawers are used to ensure cooked food remains warm before it is severed and eaten. Alternatively, warming drawers can be used to warm plates, bowls, or other items of kitchenware. In this way, it can be ensured that food is served on warm kitchenware as is generally desired both in the food service industry and private kitchens.

While warming drawers and ovens are found in personal kitchens, the majority of these devices are located in commercial kitchens. In any commercial kitchen, large quantities of food must be produced, often within a restricted timescale. As such, to ensure a commercial kitchen can produce food at the rate required, it is often necessary to pre-prepare elements of dishes before food service begins. Where food is pre-prepared, it is frequently important to maintain the temperature of this food before service, resulting in the prevalence of warming drawers and ovens in commercial kitchens.

Whilst it is important to keep warming drawers clean in a private kitchen, it is even more essential in a commercial environment. A large amount of food passing through a warming drawer in a commercial kitchen means that any lapse in hygiene could cause widespread sickness. The need to ensure cleanliness of any warming drawer is especially important as much of the food contained within has already been cooked and, therefore, there is no further cooking process which may kill unwanted bacteria.

In commercial kitchens, cleaning a warming drawer is a laborious process. Commercial warming drawers are often large and, therefore, it may be challenging to access all areas of the warming drawer during the cleaning process. Additionally, commercial warming drawers often contain internal fixtures and fittings where dirt and bacteria can accumulate during use. Such fixtures and fittings often include bars to support the moveable drawer and allow its movement within the housing, and it is in the area surrounding these bars, and in the corners of the housing, that dirt most rapidly accumulates.

### SUMMARY OF THE INVENTION

According to a first aspect of the present invention, there is provided a cleaning device for cleaning a warming drawer, the cleaning device comprising; a body portion and at least one cleaning member peripherally mounted on the body portion, wherein said body portion further comprises an aperture; or a recess in a side of the body portion; wherein the aperture or the recess extends through the thickness of the body portion.

In this way, there is advantageously provided a cleaning device which more effectively cleans the interior surfaces of a warming drawer. To clean the warming drawer, a user takes the cleaning device and position it such that the recess or aperture engages with a fixture within a housing of the warming drawer. The cleaning device is then moved along the fixture by the user to remove dirt, bacteria and/or debris due to contact between the cleaning member and the interior surfaces of the housing.

Preferably, the cleaning device comprises a plurality of cleaning members. Preferably each cleaning member of the plurality of cleaning members is peripherally mounted on the body portion. Preferably, the cleaning device comprises two cleaning members. More preferably, the two cleaning members are positioned on opposite edges of the body portion. Preferably, the cleaning device comprises three cleaning members. Preferably, the cleaning device comprises four cleaning members.

Preferably, the cleaning member or cleaning members extend around a circumference of the body portion. More preferably, the cleaning member or cleaning members extend continuously around a circumference of the body portion. Preferably, the cleaning member or cleaning members extend around more than 90%, 80%, 70% or 60% of a circumference of the body portion.

Preferably, the cleaning member or cleaning members extend along the body portion in a direction parallel to the longitudinal axis of the body portion. Preferably, two cleaning members extend along the body portion in a direction parallel to the longitudinal axis of the body portion. Alternatively, the cleaning member or cleaning members extend along the body portion in a direction perpendicular to the longitudinal axis of the body portion. Preferably, two cleaning members extend along the body portion in a direction perpendicular to the longitudinal axis of the body portion.

Most preferably, the cleaning device includes four cleaning members, two of the cleaning members extending along the body portion in a direction perpendicular to the longitudinal axis of the body portion and two of the cleaning members extending along the body portion in a direction parallel to the longitudinal axis of the body portion.

Preferably, the body portion comprises a recess in a side of the body portion, and the recess further comprises at least one projection. Preferably, the recess comprises two projections. More preferably, the projections are positioned opposite or in opposition to one another.

Preferably, the projection or projections are located such that a portion of said recess increases in width as the distance from the side of the body portion increases. Preferably, the projection or projections are located such that the portion of the recess adjacent the side of the body portion is the narrowest portion of the recess.

Preferably, the recess has a plane of symmetry. More preferably, the recess has at least two planes of symmetry.

Preferably, at least one cleaning member is located adjacent to the recess. Preferably, the cleaning member located adjacent to the recess projects outwardly from the body portion to extend across the recess.

Preferably, the body portion further comprises at least one secondary cleaning member. Preferably, the secondary cleaning member comprises a radiused brush. More preferably, the secondary cleaning member comprises a cylindrical brush. Advantageously, a radiused or cylindrical brush is advantageous as it may allow for improved cleaning in the corners of the housing or around any fixtures or fittings included in the housing.

Preferably, the cylindrical brush is positioned on the body portion such that its longitudinal axis is perpendicular to the longitudinal axis of the body portion. Preferably, the cleaning device comprises a plurality of cylindrical brushes; each positioned on the body portion such that its longitudinal axis is perpendicular to the longitudinal axis of the body portion.

Preferably, at least one secondary cleaning member is adjacent to the recess or aperture. More preferably, the secondary cleaning member is adjacent to the recess or aperture is positioned on the body portion such that its longitudinal axis is perpendicular to the longitudinal axis of the body portion.

Preferably, at least one secondary cleaning member is located adjacent to a vertex of the body portion. Preferably, at least one secondary cleaning member is located at a vertex of the body portion. More preferably, the secondary cleaning member located adjacent to or at a vertex of the body portion is positioned such that its longitudinal axis is perpendicular to the longitudinal axis of the body portion.

Preferably, the body portion further comprises a plurality of secondary cleaning members, each secondary cleaning member located at or adjacent to a vertex of the body portion.

Preferably, the body portion is substantially cuboidal. More preferably, the body portion is a rectangular cuboid. Preferably, the cleaning member comprises a brush. Preferably the aperture or recess is located within the body portion such that the body portion has a plane of symmetry. More preferably the aperture or recess is located within the body portion such that the body portion has at least two planes of symmetry.

Preferably, the body portion further comprises a socket for receiving a handle. Preferably, the socket comprises a screw thread.

According to a second aspect of the present claimed invention, there is provided a method of cleaning a warming drawer, comprising the steps of: providing a cleaning device as detailed previously, locating said recess or aperture around a fixture within the warming drawer and, moving the cleaning device along the fixture to clean the warming drawer.

As such, a method which results in improved cleaning of a warming oven is provided.

Preferably, the method comprises the step of attaching a handle to the cleaning device.

Preferably, the method comprises the step of applying a cleaning fluid, detergent, degreaser or anti-bacterial agent to the cleaning device.

According to a third aspect of the present invention, there is provided a kit of parts comprising the cleaning device as detailed previously and a handle.

### FIGURES

Embodiments of the present invention will now be described by way of example only and with reference to the accompanying drawings, in which:

FIG. 1 is a schematic frontal view of a cleaning device in accordance with the present invention;

FIG. 2 is a schematic three-quarter view of a cleaning device in accordance with the present invention;

FIG. 3 schematic rear view of a cleaning device in accordance with the present invention; and

FIG. 4 is a schematic illustration of a cleaning device in accordance with the present claimed invention in use.

### DETAILED DESCRIPTION

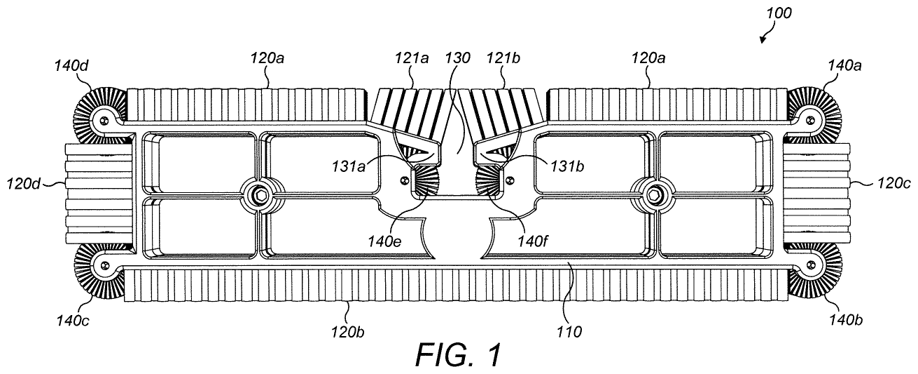

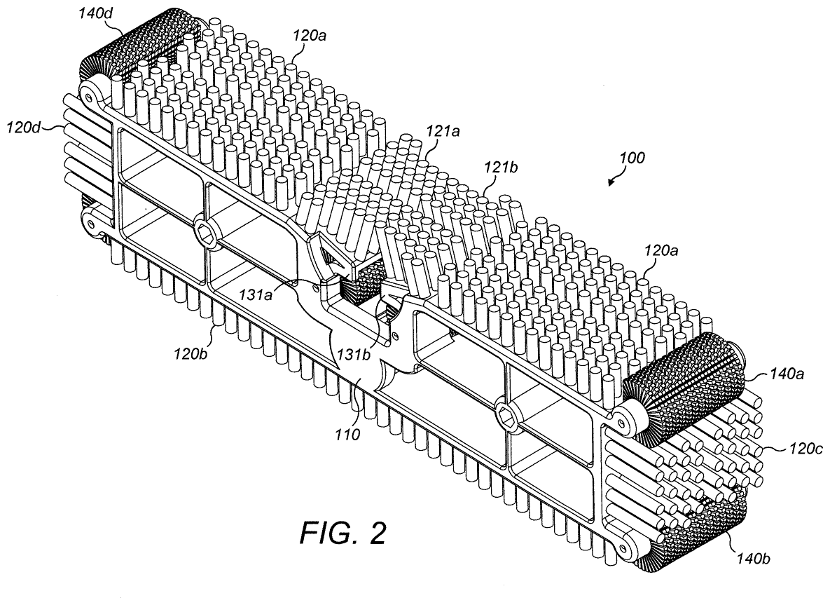

Turning to FIGS. 1 and 2, there is depicted a cleaning device 100 in accordance with the present claimed invention. Here, the cleaning device includes a body portion 110 and a plurality of cleaning members 120a-d located on the side edges of the body portion 110. Here, the body portion 110 is substantially cuboidal in shape and the cleaning members 120a-d are brushes formed of a plurality of bristles.

The body portion 110 further includes a recess or indentation 130 in the top side of the body portion. The recess 130 extends continuously from the top surface of the body portion 110 and is generally T shaped. The recess 130 is positioned generally centrally in the top surface of the body portion 110. The recess 130 extends through the entire thickness of the body portion 110, to provide a groove or channel through the cleaning device 100 which may engage with a fixture or fitting located inside the housing of a warming drawer.

The T-shaped recess 130 extends from the top surface of the body portion 110 towards the centre line of the body portion 110, such that one edge of the recess 130 defines a plane which contains the longitudinal axis of the body portion 110. At the end of the recess which intersects with the side of the body portion 110, the width of the recess 130 is narrowed by two protrusions or projections 131a, 131b. Each of these projections 131a, 131b extends from the body portion to define a narrow neck area of the recess 130. In this way, the narrowest point of the recess 130 is found where the recess 130 intersects the side of the body portion 110. In this configuration, the recess 130 has two planes of symmetry.

The projections 131a, 131b are made of a stiff material, such that they can support the weight of the cleaning device 100. In this way, the projections 131a, 131b may engage with a fixture or fitting located within the housing of a warming drawer to allow the cleaning device to be moved back and forth along the fixture or fitting during a cleaning process. The body portion 110 including the projections 131a, 131 b is typically made of a hard plastics material, commonly in a one stage moulding process.

The cleaning device further includes six secondary cleaning members 140a-f. Each of the secondary cleaning members 140a-f is in the form of a cylindrical brush mounted such that the longitudinal axis of the cylindrical brush lies perpendicular to the longitudinal axis of the body portion 110. Of the six secondary cleaning members 140a-f, four 140a-d are mounted at the corners of the body portion 110 where the sides 110 of the body portion meet one another. As such, four of the secondary cleaning members 140a-d are positioned adjacent to vertices of the body portion 110.

The remaining two secondary cleaning members 140e, 140f are located within the body portion 110 adjacent to the recess 130. As such, the final two secondary cleaning members 140e, 140f are located generally centrally within the body portion 110 such that their bristles project into the recess 130. Each of the six secondary cleaning members 140a-f is formed from a plurality of bristles located around a central axis to form a cylindrical brush. As the brush is cylindrical, it comprises two, opposing flat surfaces which define the ends of the cylinder and a curved or radiused side which forms the side of the cylinder. As such, the brush which forms the cylinder can be considered to be radiused or curved, as it includes a radiused or curved surface.

Returning to the cleaning members 120a-d, it can be seen in FIGS. 1 and 2 that the cleaning members 120a-d extend substantially around a circumference or perimeter of the body portion 110. Together, the cleaning members 120a-d and the secondary cleaning members 140a-d extend continuously around a circumference or perimeter of the body portion 110. Two of the cleaning members 120a, 120b extend along the body portion in a direction substantially parallel to the longitudinal axis of the body portion 110. Two more of the cleaning members 120c, 120d extend along the body portion in a direction substantially perpendicular to the longitudinal axis of the body portion 110.

Each of the cleaning members 120a-d is positioned such that the bristles which for the brush project outwardly from the body portion 110. In the embodiment of the invention depicted in FIGS. 1 and 2, the cleaning members 120a, 120b extending along the body portion in a direction substantially parallel to the longitudinal axis of the body portion 110 have shorter bristles than the cleaning members 120c, 120d extending along the body portion in a direction substantially perpendicular to the longitudinal axis of the body portion 110. Embodiments of the invention where the bristles of all four cleaning members 120a-d have the same length are also envisaged.

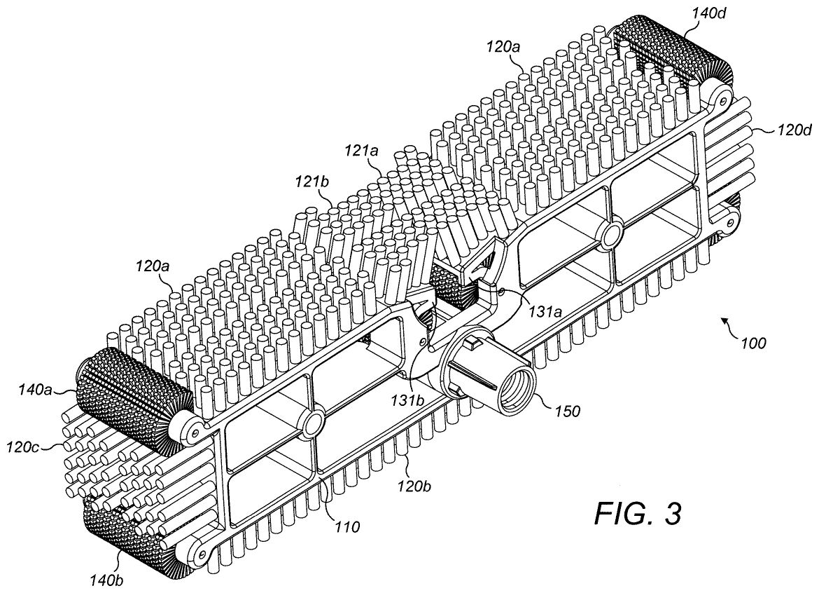

The cleaning member 120a located on the surface of the body portion 110 including the recess 130 includes two further angled portions 121a, 121b located on each side of the recess 130. In each of these angled portions 121a, 121b the bristles of the cleaning member 120a are angled or orientated towards the recess 130. As the bristles in the angled portions 121a, 121b are angled in this fashion, they extend across the recess 130 to ensure the bristles of the cleaning members 120a-d and the secondary cleaning members 140a-d form a continuous loop of cleaning material around a circumference of the cleaning device 100. Turning now to FIG. 3, the rear side of the cleaning device 100 is depicted. The rear side of the cleaning device 100 is substantially similar to the front face. However, the rear face includes a socket 150. The socket 150 protrudes from substantially the centre of the rear face of the cleaning device 100 below the recess 130 and is configured to engage with a handle. The socket 150 may engage with a handle via either a screw thread a clip fitting or an interference fit.

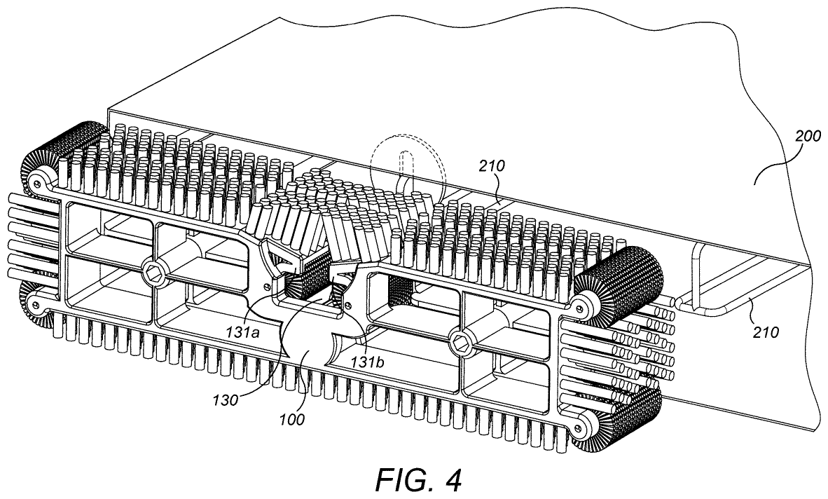

FIG. 4 depicts the insertion of the cleaning device 100 into a housing 200 of a warming drawer. In FIG. 4, the drawer itself has been removed from the warming drawer leaving only the housing 200 visible. Within the housing, fixtures 210 remain. During normal use of the warming drawer, a user may slide a drawer (not shown) within the housing 200 along the fixtures 210 to enable access to its contents. As such, it can be said that the fixtures 210 support the drawer (not shown) within the housing 200.

With the drawer (not shown) removed, the interior of the housing 200 can be cleaned more easily by a user. To facilitate the cleaning process, a user takes the cleaning device 100 and positions it such that the recess 130 surrounds and engages with a fixture 210 on the interior surface of the housing 200. With a recess configured as discussed in relation to FIGS. 1 and 2, the projections 131a, 131b rest upon the top surface of the fixture 210, supporting the weight of the cleaning device 100. As such, the cleaning device can be moved along the length of the fixture 210 to clean the interior of the housing, with the fixture itself passing through the recess 130.

As the cleaning device 100 is moved up and down the fixture 210, the cleaning members 120a-b and the secondary cleaning members 140a-d engage with and clean the interior surfaces of the housing 200. Additionally, the secondary cleaning members 140e, 140f, engage with and clean the fixture 210 upon which the cleaning device 100 is supported, ensuring the interior of the housing 200 is thoroughly cleaned. The cleaning process may be repeated with the cleaning device supported on different fixtures 210 located within the housing until the entire interior of the housing 200 has been cleaned to the required standard.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A cleaning device for cleaning a warming drawer, said cleaning device comprising:
a body portion;
at least one cleaning member peripherally mounted on said body portion;
wherein said body portion further comprises
an aperture; or
a recess in a side of said body portion;
wherein said aperture or said recess extends through the thickness of said body portion.

2. The cleaning device of claim 1, wherein said cleaning device comprises a plurality of cleaning members, each cleaning member peripherally mounted on said body portion.

3. The cleaning device of claim 1, wherein said cleaning member or cleaning members extend around a circumference of said body portion.

4. The cleaning device of claim 3, wherein said cleaning member or cleaning members extend continuously around a circumference of said body portion.

5. The cleaning device of claim 1, wherein said cleaning member or cleaning members extend along said body portion in a direction parallel to the longitudinal axis of said body portion.

6. The cleaning device of claim 1, wherein said body portion comprises a recess in a side of said body portion, and said recess further comprises at least one projection.

7. The cleaning device of claim 6, wherein said recess further comprises two projections.

8. The cleaning device of claim 7, wherein said projections are positioned in opposition to one another.

9. The cleaning device of claim 6, wherein said projection is located such that a portion of said recess increases in width as the distance from the side of said body portion increases.

10. The cleaning device of claim 9, wherein said projection is are located such that the portion of the recess adjacent the side of said body portion is the narrowest portion of said recess.

11. The cleaning device of claim 6, wherein said recess has at least two planes of symmetry.

12. The cleaning device of claim 6, wherein said at least one cleaning member is located adjacent to said recess, and further wherein said cleaning member projects outwardly from said body portion to extend across said recess.

13. The cleaning device of claim 1, wherein said body portion further comprises at least one secondary cleaning member.

14. The cleaning device of claim 13, wherein said at least one secondary cleaning member comprises a radiused brush.

15. The cleaning device of claim 14, wherein said at least one secondary cleaning member comprises a cylindrical brush.

16. The cleaning device of claim 15, wherein said cylindrical brush is positioned on said body portion such that its longitudinal axis is perpendicular to the longitudinal axis of said body portion.

17. The cleaning device of claim 13, wherein said at least one secondary cleaning member is adjacent to said recess or aperture.

18. The cleaning device of claim 13, wherein said at least one secondary cleaning member is located adjacent to a vertex of said body portion.

19. The cleaning device of claim 13, wherein said body portion further comprises a plurality of secondary cleaning members, each secondary cleaning member located adjacent to a vertex of said body portion.

20. The cleaning device of claim 1, wherein said body portion is substantially cuboidal.

21. The cleaning device of claim 1, wherein said cleaning member comprises a brush.

22. The cleaning device of claim 1, wherein said aperture or recess is located within said body portion such that said body portion has at least two planes of symmetry.

23. The cleaning device of claim 1, wherein said body portion further comprises a socket for receiving a handle.

24. A method of cleaning a warming drawer, comprising the steps of:
providing a cleaning device including:
a body portion;
at least one cleaning member peripherally mounted on said body portion;
wherein said body portion further comprises
an aperture; or
a recess in a side of said body portion;
wherein said aperture or said recess extends through the thickness of said body portion;
locating said recess or aperture around a fixture within said warming drawer; and,
moving said cleaning device along said fixture to clean said warming drawer.

25. A kit of parts comprising:
a cleaning device including:
a body portion;
at least one cleaning member peripherally mounted on said body portion;
wherein said body portion further comprises
an aperture; or
a recess in a side of said body portion;
wherein said aperture or said recess extends through the thickness of said body portion; and
a handle.
